(19) United States
(12) Patent Application Publication
(10) Pub. No.: US 2002/0000726 A1
(43) Pub. Date: Jan. 3, 2002

(54) LOCKING DEVICE IN PARTICULAR FOR MOTOR VEHICLE DOORS

(76) Inventor: ALBERT ZINTLER, GROSS-GERAU (DE)

Correspondence Address: MARTIN A FARBER, 866 UNITED NATIONS PLAZA, SUITE 473, NEW YORK, NY, 10017

(21) Appl. No.: 09/347,712

(22) Filed: Jul. 3, 1999

(30) Foreign Application Priority Data
Nov. 7, 1998 (DE) 19831260.1

(51) Int. Cl. E05C 3/06

(52) U.S. Cl. 292/216

(57) ABSTRACT

The invention relates to a locking device, in particular for vehicle doors, having lock elements such as a rotary latch and locking pawl, at least one lock element being brought from a locked position into an unlocked position at least as a function of the operation of a handle, said locking device being defined by manually operated means with which the at least one lock element can be brought from the unlocked position into the locked position, the means not being formed as a lock cylinder to be operated with a key.

The invention relates to a locking device, in particular for motor vehicle doors, having lock elements such as a rotary latch and locking pawl, according to the features of the preamble of patent claim 1.

DE 42 28 233 A1 discloses a locking device of this type, in which a rotary latch is provided which engages around or releases a locking pin in order thus to hold a door in the closed state or to permit said door to be transferred into the open state. In the locked position (door closed), the rotary latch is locked by a locking pawl, so that the locking pin is likewise locked in this position.

For the purpose of unlocking (opening the door), provision is made for the operation of a handle (such as. for example, a door inner handle or a door outer handle) to be registered by means of switches, the output signal from a switch being led to a central body electronics unit, the central body electronics unit in turn activating an actuating drive, which can likewise be referred to as a lock element. The activation of the actuating drive by the central body electronics unit has the effect that a plunger of an electromagnet forming the actuating drive is extended and, in so doing, acts on one end of the locking pawl, which is designed in the manner of a lever, with the effect that the locking pawl releases the rotary latch after the application of force by the plunger. This implements an opening aid.

Since the entire system functions only using electrical energy (central power supply of the vehicle), measures have already been taken, in DE 42 28 233 A1, to make it possible for the door to be opened when the central power supply fails. For this purpose, the handles have an operative connection, via connecting elements such as Bowden cables, levers and the like, to a specially configured locking pawl, so that in the event of a power failure the locking pawl can be unlocked by means of mechanical operation of the handle and thus the door can be opened. This is particularly important from the safety point of view, since it is necessary to avoid persons being shut in the vehicle in the event of power failure.

However, these means, which constitute mechanical redundancy, are only suitable to unlock the locking pawl in the event of a power failure in order that the door can be opened. However, no consideration has been given to the case in which the power has failed and the locking pawl is in the unlocked position. For this case, although it would be possible to open the door, the effective closure (locking) of the door is not possible. This is particularly disadvantageous, when in an emergency (for example power failure of the central power supply) the vehicle has to be left by the occupants but cannot be effectively locked.

DE 196 19 849 A1 likewise discloses a locking device which is based on the principle that the locking pawl, when unlocking is to take place, is brought into an operative connection with the handle via a coupler element and Bowden cables, so that the operation of a handle has the effect of unlocking the locking pawl and hence the rotary latch. If no unlocking is to take place (for example in the anti-theft position), the coupler element is brought into such a position that the operation of the handle “is lost”, and the locking pawl continues to lock the rotary latch. In order to move the coupler element from one position into the other, provision is made for an actuating drive which can be activated by a control device and which in this case is once more designed as an electromagnet with a plunger and a lever acting on the coupler element. In the case of this locking device, disclosed by DE 196 19 849 A1, although measures have already been taken to move the coupler element in an emergency (in particular in the case of a power failure which no longer permits any movement of the actuating drive), these means are a lock cylinder which is connected via connecting elements to the coupler element, in order thus to be able to move the coupler element to and fro into its two positions by means of a key which can be inserted into the lock cylinder. Although this intrinsically functions satisfactorily, it is inconsistent with the current demands for comfort of modern vehicles, since in the latter case so-called “keyless entry”, that is to say entry to the vehicle without an ignition key known per se, is required. This means that in order to actuate the central locking mechanism (unlocking and locking of the doors and the like), a remote control is used, via which the central locking system is operated by means of pressure on a push button. This lock cylinder, and the associated carrying of an appropriate key, thus constitute a state which is no longer tolerable from the current points of view of convenience.

The invention is therefore based on the object of providing a locking device which not only functions reliably, but also in an emergency, can not only be unlocked but primarily can also be locked without a key.

This object is achieved by the features of patent claim 1.

According to the invention, manually operated means are provided with which the at least one lock element can be brought from the unlocked position into the locked position, the means not being formed as a lock cylinder to be operated with a key.

From the cited prior art, it was known to configure the locking device in such a way that, in an emergency, the doors can be opened via the handles. The invention also solves the problem that the locking device can also be brought into the locked position when there is an emergency, in particular a failure of the power supply. It is thus ensured that the vehicle can be left by the occupants during this emergency and, above all, can also be locked, in order that said occupants can get away from the vehicle. It is therefore possible for the occupants to get away from the vehicle, which is in particular necessary when the vehicle has to be left on a busy road (in particular the shoulder of an expressway). Only when the power supply is established does the locked device become ready to operate again, so that this set locking position can be canceled. A power failure of this type may take place, for example, as a result of a defective battery, a cable break, a crash or the like.

In a development of the invention, the means act on a coupler element operated by an actuating drive, the effect of the coupler element being that an operative connection can be produced or not produced between a handle and the lock element. This configuration relates to a locking device which is configured in accordance with DE 196 19 849 A1. To this extent, reference is also made to the configuration and mode of action of the locking device described in DE 196 19 849 A1. This means that the means with which the at least one look element can be brought from the unlocked position into the locked position can act on a lock element such as a rotary latch or locking pawl, but also on lock elements such as actuating drive, plunger or lever of the actuating drive and the like. The factor which is common to all the embodiments is that the means according to the invention can be used to lock the vehicle, at least one door, in order to permit the vehicle to be left.

In a development of the invention, the means act on an actuating drive the effect of which is that a lock element, in particular a locking pawl, can be brought from the unlocked position into the locked position. This embodiment relates to the configuration of the locking device disclosed by DE 42 28 233 A1, so that reference is again made to the configuration and mode of action of this known locking device.

In a development of the invention, the means can be operated only with the effect of operation in the direction of the locked position. This has the advantage that the operation of the means has the effect only of locking but not of unlocking, so that operating the means with the effect of an operation in the direction of the unlocked position could not lead to the doors being opened and thus to the vehicle being stolen.

In a development of the invention, an operating part of the means is arranged at such a point in a door or the like of the vehicle that the point at which the operating part for manual operation is arranged cannot be reached when the door is closed but can be reached when the door is open. This also achieves the situation in which the means can be reached when the door is open. Furthermore, this prevents the operating part, such as for example a lever projecting beyond the outer surface of the door, being able to be misused to open the door. This is because after the door has been opened in an emergency by operating the handle, by means of the already known mechanical redundancy, the operating part can be operated in order to bring the locking device from the unlocked position into the locked position. The door can then be closed and is thus automatically locked. At the same time, the point at which the operating part is arranged is no longer accessible; so that unlocking cannot take place. One advantageous arrangement of such an operating part is one end of the door, in which the locking pin is also arranged on the door or on a column of the vehicle. However, an arrangement of the operating part in the direction of the interior of the vehicle is also conceivable, so that in such a case any persons who may still be in the vehicle are able to leave the latter.

In a development of the invention, the means can be fixed in the at least two positions “unlocked” and “locked”. This ensures that the means cannot be brought from the unlocked position into the locked position inadvertently, in particular by vibration of the vehicle, as a result of which opening the doors inadvertently would no longer be possible, and which is effectively prevented in this way.

In the description at the beginning and in the following description of the figures, reference has been made in each case to the two locking devices disclosed by DE 42 28 233 A1 and DE 196 19 849 A1, but the idea of the invention is not restricted to these known configurations.

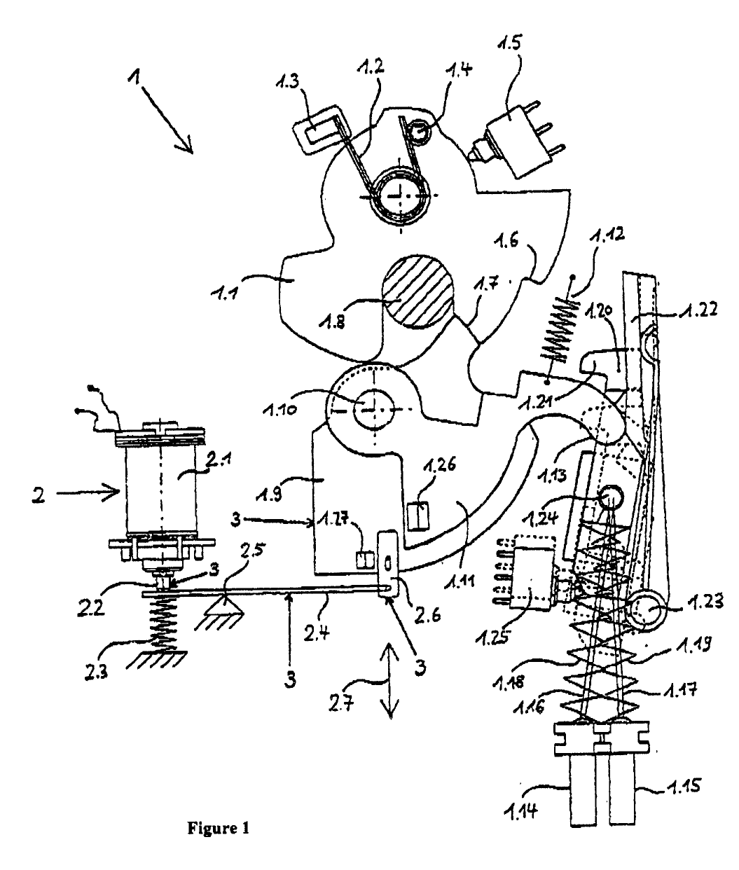

An exemplary embodiment of a locking device according to the invention is described in the following text and explained using FIG. 1.

A locking device 1 shown in FIG. 1 has a rotary latch 1.1, which acts counter to a rotary latch spring 1.2, the rotary latch spring 1.2 being clamped between a fixed stop 1.3 and a stop 1.4 arranged on the rotary latch 1.1. The position of the rotary latch 1.1 can be registered by means of a rotary latch switch 1.5. Furthermore, the rotary latch 1.1 has an offset 1.6, with which an intermediate latching position (pre-latch) is implemented. Furthermore, there is a bearing face 1.7, via which the rotary latch 1.1 can be retained in its locking position. The rotary latch 1.1, which is of U-shaped configuration, encloses a cotter 1.8 with its two legs, and thus, for example, holds a vehicle door in its closed position in a manner known per se. A locking pawl 1.9, which can be pivoted about a pivot 1.10, rests with a projection (not specifically designated) in FIG. 1 on the bearing face 1.7 of the rotary latch 1.1. Likewise mounted about the pivot 1.10 or about another pivot is a coupler element 1.11, which is held in the position shown in FIG. 1 (if necessary whilst resting on a stop—not illustrated) by a spring 1.12. Means which permit the coupler element 1.11 to rotate about the pivot 1.10 out of its position shown engage on a protrusion 1.13 on the coupler element 1.11. These means are connected, for example, to a door inner handle or a door outer handle or other handles, with which the couplet element 1.11 can be operated mechanically. FIG. 1 illustrates that these means are Bowden cables 1.14 and 1.15, each having a core 1.16 and 1.17, which are in turn pre-tensioned by means of springs 1.18 and 1.19, respectively. The cores 1.16 and 1.17 operate a lever 1.20, which has a protrusion 1.21 or an approximately triangular lug which rests on the protrusion 1.13 and which, when the door inner handle or the door outer handle is operated, is brought into operative connection with the protrusion 1.13, so that the coupler element 1.11 is rotated and, under certain circumstances, which will be explained further below, brings the locking pawl 1.9 from its locking position (shown) into an opening position, so that the rotary latch 1.1 releases the cotter 1.8. The lever 1.20 is, for example, arranged in a linearly displaceable manner on a bearing part 1.22, it being possible, but not essential, for this bearing part 1.22 to be pivotable about a pivot 1.23. The cores 1.16 and 1.17 are fastened to a fixing point 1.24 on the lever 1.20. This fixing point 1.24 can be configured in such a way that the operation of the door inner handle is independent of any movement of the door outer handle and vice versa. The operation can be registered by means of a switch 1.25.

In order to operate the locking device 1, an actuating device 2 is provided, which is, for example, an electromagnet 2.1 having a linearly displaceable actuating element 2.2, which may or may not act counter to a spring 2.3. The displacement of the actuating element 2.2 acts on a lever 2.4 which is pivotable about a pivot 2.5. Instead of the linear motion, an actuating device having a rotary motion or a combination of the two may be provided. The action of pivoting the lever about the pivot 2.5 has the effect of an essentially linear displacement of a coupler element 2.6 in a direction of motion 2.7. It is also conceivable for the actuating device to act on the coupler element 2.6 directly or with a step down or step up, linear or rotary motion also being conceivable again. FIG. 1 shows that the coupler element 2.6 essentially has an elongate rectangular shape, other embodiments adapted to the designs (such as for example a wedge-like configuration) being conceivable. It is further conceivable for the coupler element 2.6 and/or the components operating the coupler element 2.6 (for example the actuating device 2, lever 2.4) to be arranged on the locking pawl 1.9 or the coupler element 1.11.

The coupler element 1.11 has a stop 1.26, and the locking pawl 1.9 has a stop 1.27, which are arranged offset in relation to each other, it being possible for the coupler element 2.6 to be located between the two stops 1.26 and 1.27 or, following operation of the actuating device 2, to be displaceable out of this region of the stops, or vice versa. If the coupler element 2.6 is in the coupled position (the uncoupled position is shown in FIG. 1), when the door inner handle or door outer handle is operated, the stop 1.26 is pressed against the coupler element 2.6 as a result of rotation of the coupler element 1.11, and the coupler element 2.6 is pressed against the stop 1.27 of the locking pawl 1.9, so that in this way the locking pawl 1.9 is moved out of its locking position into its opening position, and hence releases the rotary latch 1.1. If, by means of appropriate activation of the actuating device 2, the coupler element 2.6 is moved out of the region of the stops (in particular out of the region of the stop 1.26), although the coupler element 1.11 can be pivoted about the pivot 1.10 as a result of the door inner handle or door outer handle being operated, it is not possible for the locking pawl 1.9 to be driven as well, so that the rotary latch 1.1 and hence the cotter 1.8 cannot be released, by which means an anti-theft position and, in addition, a child safeguard and the prevention of undesired opening from outside are achieved.

In relation to the position of the coupler element 2.6 in the anti-theft position or, respectively, in an unlocked position, there are several possibilities. One is that the coupler element 2.6 is fundamentally (for example when the actuating device 2 is not operated and if the spring 2.3 is configured as a compression spring) located outside the region of the stops 1.26 and 1.27 (anti-theft position). When the handle is operated following an opening request from the operator, which is legitimized, for example by a hand-held transmitter, and has output an appropriate transmitting command, the switch 1.25, which is then switched into the active state, and proceeding from this the actuating device 2 are then operated, and the coupler element 2.6 is moved into the region of the stops 1.26 and 1.27, before the protrusion 1.21 of the level 1.20 carries along the protrusion 1.13 of the coupler element 1.11 and releases the rotary latch 1.1. Furthermore, it is conceivable to leave the coupler element 2.6 in the region between the stops 1.26 and 1.27 when the actuating device is in the non-operated state, and to move it out of this region (by operating the actuating device 2) only for the case in which the anti-theft safeguard or a child safeguard are introduced.

The arrows bearing the reference number 3 indicate the points of the action of the manually operated means with which the at least one lock element, such as rotary latch 1.1, locking pawl 1.9, the coupler element 2.6 or else parts of the actuating drive 2, can be brought from the unlocked position into the locked position.

List of reference symbols:

1 Locking device

1.1 Rotary latch

1.2 Rotary latch spring

1.3 Fixed stop

1.4 Stop

1.5 Rotary latch switch

1.6 Offset

1.7 Bearing face

1.8 Cotter

1.9 Locking pawl

1.10 Pivot

1.11 Coupler element

1.12 Spring

1.13 Protrusion

1.14 Bowden cable

1.15 Bowden cable

1.16 Core

1.17 Core

1.18 Spring

1.19 Spring

1.20 Lever

1.21 Protrusion

1.22 Bearing part

1.23 Pivot

1.24 Fixing point

1.25 Switch

2 Actuating device

1.26 Electromagnet

1.27 Displaceable actuating element

1.28 Spring

1.29 Lever

1.30 Pivot

1.31 Coupler element

1.32 Direction of motion

3 Points of action

1. A locking device, in particular for vehicle doors, having lock elements such a rotary latch and locking pawl, at least one lock element being brought from a locked position into an unlocked position at least as a function of the operation of a handle defined by manually operated leans with which the at least one lock element can be brought from the unlocked position into the locked position, the means not being formed as a lock cylinder to be operated with a key.

2. The locking device as claimed in claim 1, wherein the means act on a coupler element operated by an actuating drive, the effect of the coupler element being that an operative connection can be produced or not produced between a handle and the lock element.

3. The locking device as claimed in claim 1 or 2, wherein the means act on an actuating drive, the effect of the actuating drive being that a lock element, in particular a locking pawl, can be brought from the locked position into the unlocked position.

4. The locking device as claimed in one of the preceding claims, wherein the means can be operated only with the effect of operation in the direction of the locked position.

5. The locking device as claimed in one of the preceding claims, wherein an operating part of the means is arranged at such a point in a door or the like of the vehicle such that in order to operate the operating part manually, said point cannot be reached when the door is closed but can be reached when the door is open.

6. The locking device as claimed in one of the preceding claims, wherein the means can be fixed in the at least two positions “unlocked” and “locked”.
